(19) United States
(12) Patent Application Publication
(10) Pub. No.: US 2004/0233894 A1
(43) Pub. Date: Nov. 25, 2004

(54) Method and system for consulting remotely

(76) Inventor: Jonathan Rutland, Darling Point (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/484,068

(22) PCT Filed: Jul. 18, 2002
(86) PCT No.: PCT/AU02/00964

(30) Foreign Application Priority Data
Jul. 18, 2001 (AU) PR 6449

(51) Int. Cl. H04L 12/66

(52) U.S. Cl. 370/352

(57) ABSTRACT

A micro billing system comprising a data base; a communications system for putting a client in communication with a consultant whereby said consultant can provide a consultant to client consultation via said communications system; said data base tracking each said consultation so as to provide an individual bill for a billing event.

### FIELD OF THE INVENTION

This invention relates to a method and system for consulting remotely, in particular but not exclusively in the private health care environment.

### BACKGROUND OF THE INVENTION

Traditionally, when dealing with patients, medical practitioners bill only for face-to-face consultations Nowadays, a significant portion of a doctor's billable time is spent in consulting with patients over the telephone and speaking to other doctors about patients. Both due to traditional and administrative hurdles, such time is rarely, if ever, billed out.

As a result, private medical practitioners can only afford to spend a limited amount of unremunerated time consulting by telephone. Whilst a face-to-face consultation is usually necessary to make a full clinical diagnosis, in many cases it is possible to provide a certain level of advice remotely (especially for subsequent consultations).

It is an object of the present invention to address or ameliorate one or more of the above mentioned disadvantages.

### SUMMARY OF THE INVENTION

Accordingly, in one broad form of the invention, there is provided a remote consulting system for allowing a client to consult remotely with a consultant over a telecommunications network, the system including:

user interface means for initiating lines of communication between clients and consultants, and for enabling the setting up of a remote consultation between a client and a consultant:

at least one user database including consultant and client records;

a time record database including at least time records of consultations between consultants and clients; and

a billing system in communication with the time record database for automatically billing a client for the remote consultation.

Preferably, the billing system is arranged to bill the client on a time basis, and includes computation means arranged to retrieve timing data from the consultation record database, the billing system including a rates database containing rates data in respect of the various consultants for enabling a consultation fee to be calculated on the basis of the timing data.

Typically, booking means are provided for booking consultations, the booking means including consultations request storage and retrieval means which are accessible by a selected consultant.

The consultation may be telephone- or email-based.

The billing system may also be arranged to bill the client on a fixed fee basis, in particular where the consultation is based on an exchange of emails rather than a telephone-based consultation.

The user interface means may include a user interface hub in the form of an interactive voice response (IVR) system, and/or a browser-enabled entry facility for enabling users to access the service and databases via the web. A call centre and a messaging system may also be provided. Preferably, the user interface hub includes all interface options.

According to a further aspect of the invention there is provided a method of consulting remotely comprising the steps of:

initiating a remote consultation request via a telecommunications network by means of a user interface hub;

establishing a telecommunications link between a client and a predetermined consultant in response to the request in the event of the consultant being available for consulting;

booking and storing a remote consultation request in the event of the consultant being unavailable for consulting;

retrieving the consultation request and initiating the remote consultation;

timing the duration of the consultation over the link; and

charging for the consultation, preferably by automatically generating a bill, the quantum of the bill typically being calculated on the basis of the timed duration of the link.

Conveniently the telecommunications link is a telephone link.

According to a still further aspect of the invention there is provided the method of consulting remotely comprising the steps of;

initiating a remote consultation request over a telecommunications network by means of a user interface hub;

generating a consultation query over the network for at least one selected consultant;

enabling the consultation query to be retrieved by the consultant;

enabling the consultant to respond via the telecommunications network; and

generating a bill in respect of the response.

In the latter method, the consultation is preferably email-based.

In a further form of the invention there is provided a micro billing system comprising a data base;

a communications system for putting a client in communication with a consultant whereby said consultant can provide a consultant to client consultation via said communications system; said data base tracking each said consultation so as to provide an individual bill for a billing event.

Preferably said billing event is said consultation.

Preferably said communications system includes directing means in communication with said database.

Preferably said directing means is a user interface hub.

Preferably said consultation is initiated by said client identifying him/herself to said directing means.

Preferably said directing means determines if said client is a preexisting client with reference to said database.

Preferably said step of identifying includes a step of obtaining a unique identifying feature of said client.

Preferably said unique identifying feature is a PIN number.

Preferably said communications system comprises a voice communications system.

Preferably said communications system comprises a text communications system.

Preferably said individual bill is based on duration of said consultation.

Preferably said client is located remotely from said consultant.

Preferably said system is adapted to apportion receipts of said bills between stakeholders in said system.

Preferably said stakeholders include said consultant.

Preferably said system includes identity reporting means whereby the identity of said client is communicated to said consultant before said consultation is initiated.

Preferably said communications system provides means for said consultant to accept or reject or postpone a consultation.

Preferably in the event said consultant postpones said consultation, said consultant can initiate consultation at a later time determined by said consultant.

Preferably said consultant can initiate consultation at a later time determined by said consultant following initial reference by said consultant to said directing means.

Preferably said communications system causes communication in the following steps:

a) client to directing means

b) consultant to directing means

c) consultant to client.

Preferably said consultant to client interaction is a duplex action.

Preferably said duplex interaction is a voice to voice interaction.

Preferably said duplex interaction is a chat interaction.

Preferably said step of communication between said client and said directing means is a simplex interaction.

Preferably said step of said client to said directing means communication is a duplex interaction.

Preferably said step of consultant to directing means communication is a simplex interaction.

Preferably said step of consultant to directing means communication is a duplex interaction.

Preferably said step of client to directing means communication is not billed.

Preferably said step of consultant to directing means communication is not billed.

Preferably said step of consultant to client communication is billed.

Preferably said system incorporates call back means whereby said consultant can initiate said client consultation at a later time.

Preferably said client can nominate preferred times for call back to said system.

### BRIEF DESCRIPTION OF THE DRAWINGS

Embodiments of the present invention will now be described with reference to the accompanying drawings wherein:—

FIG. 1 shows a schematic block diagram of a micro billing system in accordance with a generalized embodiment of the present invention,

FIG. 2 shows a flow chart of interactions between the client, the consultant and the directing means for the system of FIG. 1,

FIG. 3 shows a block diagram of a remote consulting system in accordance with a first preferred embodiment of the present invention,

FIG. 4 shows a schematic flow diagram of various web based options that the remote consulting system of embodiments of the invention may provide for a client;

FIG. 5 shows a schematic flow diagram of various web-based options that the remote consulting system provides for a consultant;

FIG. 6 shows a flow diagram of those steps involved in a phone-based embodiment of the remote consulting method of the invention, when initiated by a client call;

FIG. 7 shows a flow diagram of those steps involved in a phone-based embodiment of the remote consulting method, when initiated by a consultant call; and

FIG. 8 shows a sub-routine of the flow diagram of FIG. 7 in which a call is initiated by the consultant.

### DETAILED DESCRIPTION OF THE EMBODIMENTS

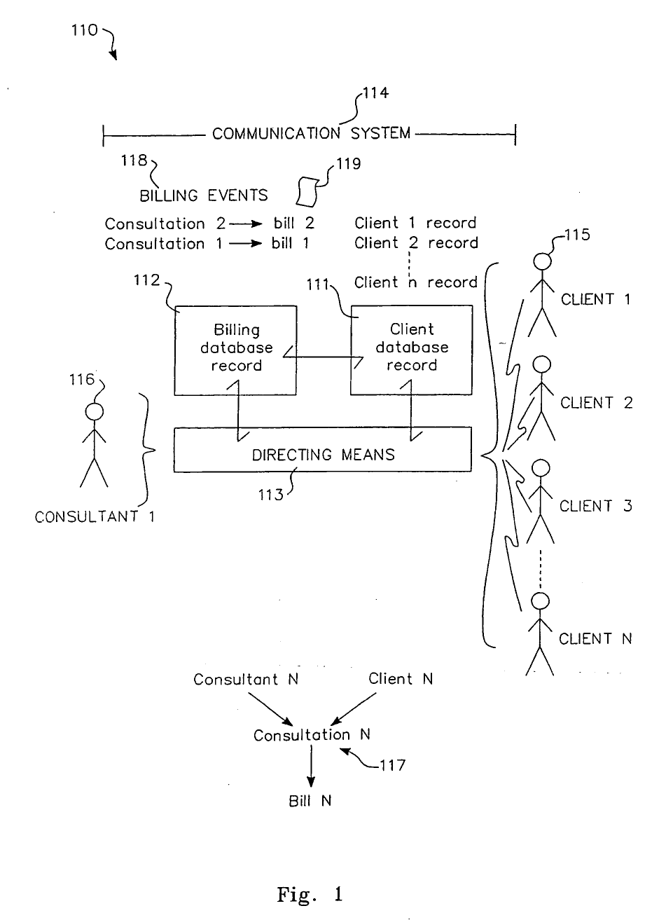

With reference to FIG. 1 there is illustrated a micro billing system 110 in accordance with a generalised embodiment of the present invention.

The term “micro billing” is used in this specification to indicate a system adapted to bill for relatively small units of work, most commonly in this instance for individual telephonic consultations between a client and a consultant.

In this instance the micro billing system 110 comprises a client data base record 111 and a billing data base record 112 in communication with each other and with directing means 113.

The directing means 113 is adapted to work in conjunction with communications system 114 whereby one or more clients including first client 115 can be put in communication with one or more consultants including first consultant 116.

The client data base record 111 is adapted to maintain a plurality of client records, one for each client 115.

The directing means 113 is adapted to operate in conjunction with communication system 114 whereby, for example, first client 115 who desires a consultation with first consultant 116 may initiate a communication via communications system 114 initially with directing means 113.

Directing means 113 ultimately puts first client 115 in communication with first consultant 116 via communications system 114 thereby initiating a consultation 117.

A record of consultation 117 is stored as a billing record in billing data base record 112 as a billing event 118.

In this instance billing event 118 corresponds to a first consultation put in train by directing means 113 between first client 115 and first consultant 116.

Billing event 118 gives rise to bill 119 generated by appropriate interaction between directing means 113, client data base record 111 and billing data base record 112.

In this particular instance the billing event comprises a single consultation between first client 115 and first consultant 116 and the bill 119 arising from the billing event comprising this single consultation is a bill based on the duration of the consultation 117 and with reference to the time charge out rate of first consultant 116. So, for example, if the consultation 117 lasted 5 minutes then bill 119 would be calculated as 5 minutes×the charge out rate per unit time of first consultant 116, say for example A$1 per minute giving rise to a bill of A$5. By utilizing the client data base record 111 the bill can be immediately addressed to first client 115. In one form this can be implemented electronically by direct credit or debit card deduction.

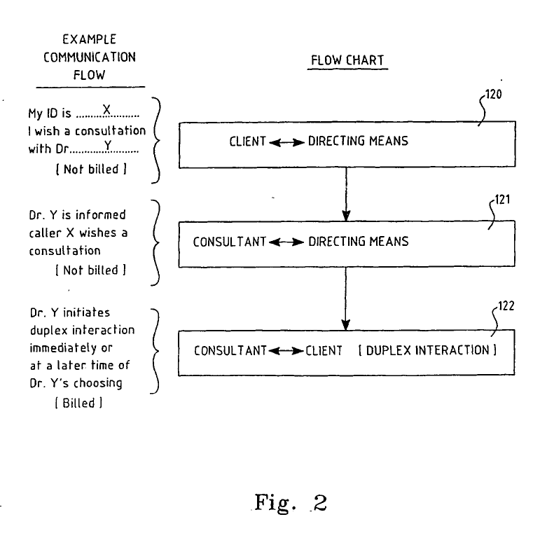

With reference to FIG. 2 a typical flow chart for interaction between the client, the consultant and the directing means of FIG. 1 is illustrated.

In any given sequence there will be an initial interaction between client 115 and the directing means 113 as indicated by box 120. As indicated in the example to the left of box 120 this interaction can be a simple interaction where the client states “My ID is X. I wish a consultation with Doctor Y”. This portion of the interaction with system 110 is not billed.

The directing means 113 will then communicate with consultant 116 as indicated in box 121. This communication may be audio, text or otherwise and is to the effect that Doctor Y is informed that caller with ID X wishes a consultation. Again, this portion of the interaction is not billed.

Finally, as indicated in box 122 interaction direct between the consultant and the client is initiated. This communication can be initiated immediately or at a later time of Doctor Y's choosing. This portion of the interaction is billed, typically on a time basis as described later in this specification although other forms of basis for billing can be used. This interaction is a duplex interaction in that communication is two way at any given instant. Exemplary forms of interaction include telephone. Other forms of duplex interaction can include chat as implemented by the internet. An e-mail interaction is not considered a duplex interaction because, at any given instant, communication is, in effect, only one way (termed “simplex”) either from consultant to client or client to consultant.

By contrast the communications of box 120 and 121 can be simplex or duplex depending on system implementation.

As will be explained in greater detail in the embodiments described below micro billing system 110 can include a call back feature within directing means 113 whereby contact details for client 115 are taken by the system sufficient to allow consultant 116 to have sufficient contact information to initiate a call back by the consultant to the client at later time.

In one particular form client 115 can nominate preferred times for the call back to the directing means 113 for relaying to consultant 116.

First Embodiment

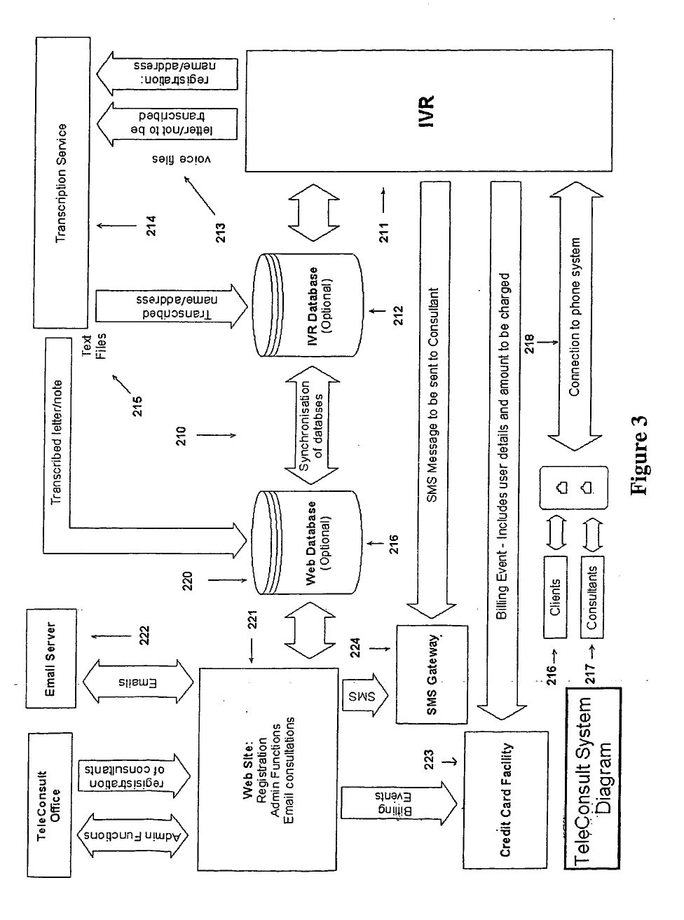

With reference to FIG. 3 there is illustrated a block diagram of a billing system 210 in accordance with a first detailed embodiment of the present invention.

In this instance the directing means 113 takes the form of an interactive voice response (IVR) system 211. In this instance the interactive voice response system 211 is in communication with a data base 212 which is adapted to maintain a data base of client records, in this instance generated via voice files 213 which are transcribed from the interactive voice response system 211 by transcriptions system 214 and input into the data base 212, in this instance in the form of text files 215.

In this instance the primary form of communication between the system 210 and both clients 216 and consultants 217 is via the public switched phone system (PSTN) system 218.

In this instance the interactive voice response system 211 does have secondary communication ability including the ability to send SMS messages to an SMS gateway 224. In this instance this secondary message facility is used to communicate with consultants 217.

In use the system of FIG. 3 fields telephone calls from prospective clients 216 via phone system 218 with client details being stored via transcription system 214 in data base 212. The system either puts clients 216 in direct telephonic contact with appropriate consultants 217, again via telephone system 218 or, in the event a consultant is not immediately available, or for other reasons, can set up a deferred consultation by firstly taking the client details and then sending an SMS message via gateway 224 to an appropriate consultant 217. The consultant can then contact at a later time the client 216 on the basis of contact details contained in the SMS message thereby generating a billing event in the form of a time consultation.

In a more sophisticated form the system 210 can be enabled with tertiary communication means, in this instance in the form of communication via the world wide interconnected network of computers commonly known as the “web”. In this event data base 212 can be synchronised with a web-enabled data base 220 through which a website 221 can be maintained. With this arrangement, in addition to or instead of SMS messaging it is possible to arrange communication between the system 210 and consultants 217 via e-mail on e-mail server 222.

Also, with this tertiary form of communication, billing events can be orchestrated through website 221 rather than directly via the interactive voice response system 211.

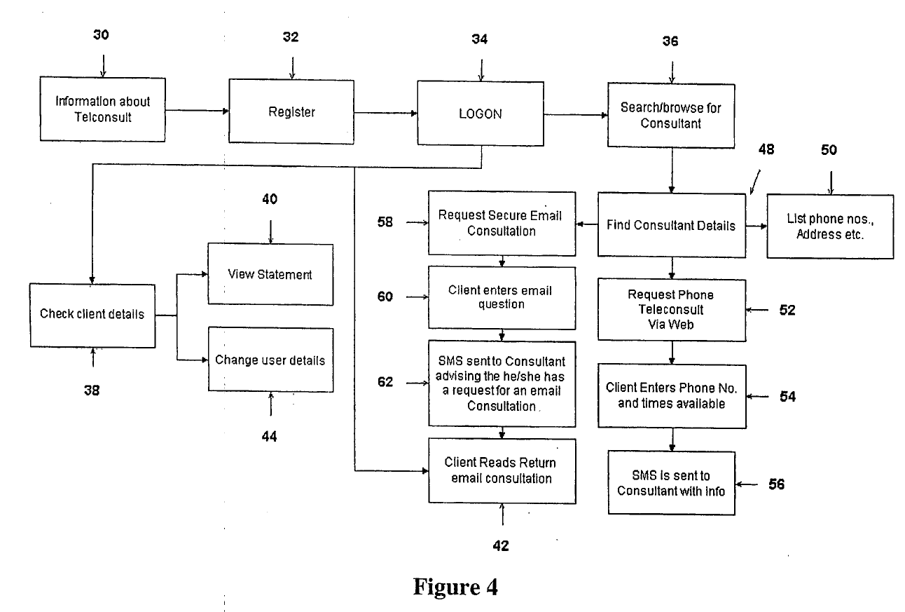

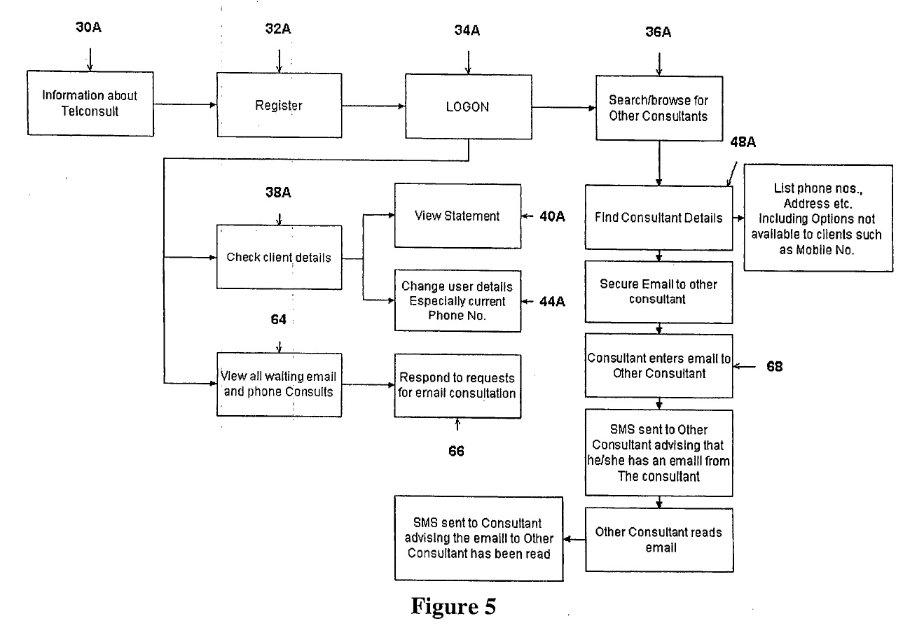

The consulting system will now be described in broader outline with reference to the client and consultant options diagrams illustrated in FIGS. 4 and 5 respectively. FIG. 4 schematically and sequentially illustrates part of the graphical user interface available to a client at the website 221. The client may select various options, depending on his or her status. A new client initially obtains further information about the service 30, and registers at 32. An existing client 34 logs on immediately, searching for a consultant 36 and checking account details 38. The latter allows the client to access his or her password protected portion of an accounts database to view statements 40, read return email 42, and initiate a secure process for changing user details 44. It will be appreciated that one of many applications of the system is in the private health care environment. As a result, in this embodiment, the terms “consultant” and “doctor” are used interchangeably, as are the terms “client” and “patient”.

The system allows patients to consult with doctors either telephonically via the IVR system 211 or electronically via the website 221. The consultation initiation procedure can utilise either the IVR system or the website. It will be appreciated that the website may be used to set up both a phone and an email consultation. The IVR is generally used to set up a phone consultation, but in certain cases may even be used to set up an email consultation.

Typically, in the IVR initiated embodiment, patients will dial a telephone number of the IVR system, and then will be invited to enter their ID and PIN numbers, followed by the ID number of the consultant they are seeking. This number will be available either from the consultant, from the website or via the IVR using an automatic doctor retrieval protocol. A message will be sent to the default telephone number of the consultant via the IVR system. If the consultant answers the phone, he will hear a voice message advising him of a telephone consultation.

He will then have the option of taking the call or hanging up. If he does not answer the call or if he hangs up he will receive a voicemail or SMS message to the effect that a telephone consultation has been requested, incorporating details of the caller. He can then return this at his convenience. If the call proceeds the caller is charged according to the rate specified by the consultant for the duration of the call.

If the consultation does not proceed immediately, the patient receives a message that the doctor is unavailable. The patient can then terminate the call or request a return telephone consultation, indicating, using the keys of the telephone, the times when he will be available and the telephone number on which he would like to be called back. This information will be available to the consultant when he returns the call through the IVR. The steps involved in requesting a telephone consultation, client or IVR accessing of the consultant details, client entry of the phone number and the available times, and conveying this information to the consultant, are illustrated at 48 to 56 respectively. An email consultation can also be requested, as is shown at 58. The email query is entered by the patient at 60 after which an SMS or other message is sent to the consultant advising him or her of the request at 62.

In FIG. 5, the various consultant options are illustrated stepwise. Where these are the same as the client or patient options, these are indicated with the same numeral followed by the suffix “A”. The consultant options may also include viewing all waiting email 64 and responding to requests for email consultation 66. The various steps involved in communicating with other consultants are illustrated in detail at the sequence 68.

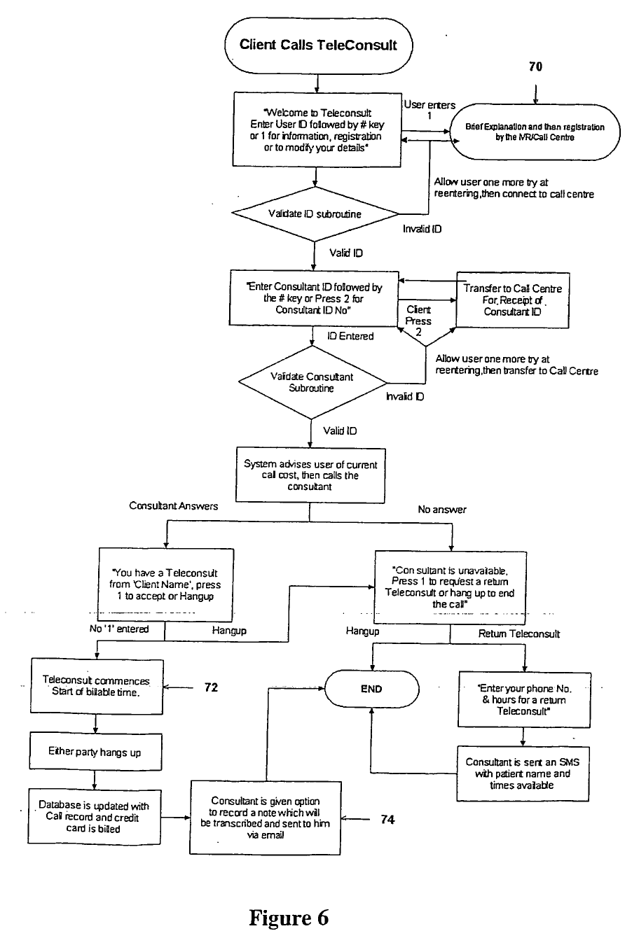

Referring now to FIG. 6, the flow diagram illustrates various steps involved when a client or patient calls the IVR system. These steps are largely self-explanatory. A registration step 70 is included in the event of registration being required at the IVR system 211 or call centre.

In the billing routine illustrated at 72, the timing of the call is initiated on acceptance by the consultant of the call.

When either party hangs up, the call record database 212 is updated with the call record, including the consultant and patient details, the time of the call and the fee, which is calculated on a rate-per-minute basis for the particular consultant. This information is then transferred to the billing system, and payment is effected via the credit card processing facility 223 by extracting the credit card details.

In an email consultation which may occur over a period of time a maximum fixed rate may be charged or the consultant may enter an hourly rate on the basis of the time taken by the consultant to read and respond to the email. Typically, on initiating the consultation, the client is provided with the consultant's charge out rate, up to a maximum charge. It is left to the consultant to bill out the email consultation on a time basis, up to an agreed maximum.

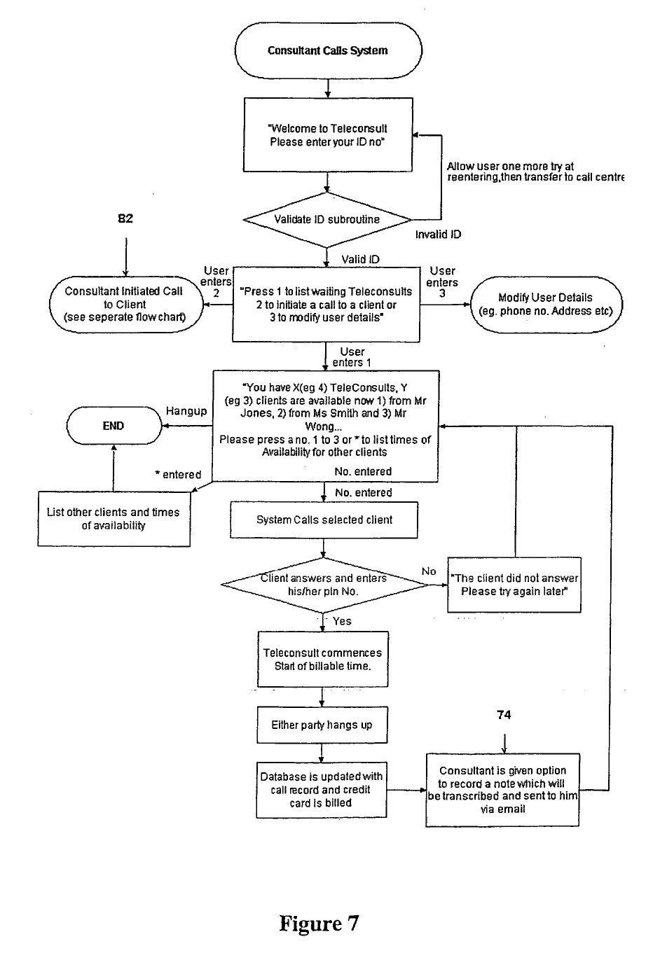

The flow diagram of FIG. 7 shows the various steps involved when the consultant causes the system to extract all of the messages and client availabilities. In both the client- and consultant-initiated procedures, the consultant is given an option at 74 to record a note of the consultation, a letter or other document. The recorded note of the consultation is temporarily recorded by the IVR system in a voice file. The voice file 213 is deleted from the IVR system, and is downloaded to a transcription service 214, which may include voice-to-text software to convert the voice file into a text file 215, which is subsequently emailed back to the consultant for his records. These records could include a patient file in which all of the call record information, including the billing information, is also stored.

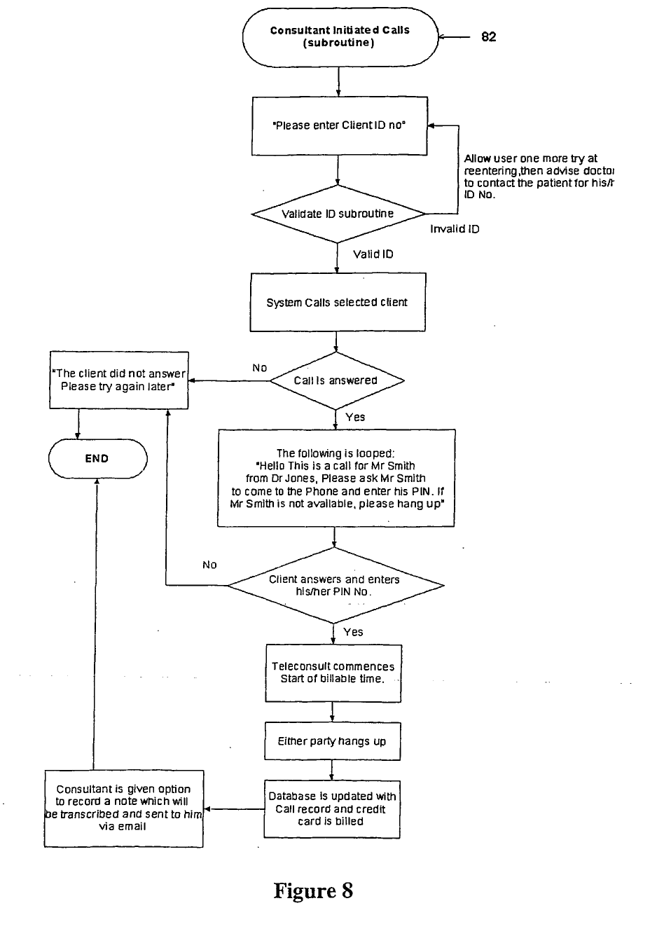

The flow diagram of FIG. 8 illustrates various steps taken by the consultant in the subroutine commencing at 82 in FIG. 7, in which the consultant initiates a call to the patient.

As described earlier, in one particular form, the directing means can be implemented as a commercially available interactive voice response system (IVR) in conjunction with manual transcription for entry into a commercially available data base. Such data bases can include, Oracle™ implemented on platforms such as the Microsoft Windows platform or the Linux platform.

It will be understood that the invention disclosed and defined herein extends to all alternative combinations of two or more of the individual features mentioned or evident from the text or drawings. All of these different combinations constitute various alternative aspects of the invention.

It will also be understood that the invention extends to all types of consultants and professionals including but not limited to solicitors, management consultants, IT consultants, and accountants, and is not restricted to the health care environment.

The foregoing describes embodiments of the present invention and modifications, obvious to those skilled in the art can be made thereto, without departing from the scope of the present invention.

### INDUSTRIAL APPLICABILITY

Embodiments of the invention can be applied in individual medical practices, or in further forms, as a bureau service wherein a single system is utilized to serve a number of separate consultancies, each consultancy having a separate membership to the system.

What is claimed is:

1-324. cancelled.

325. A microbilling system for consulting remotely, concurrently and interactively; said system incorporating means to implement the steps of:
(i) initiating a remote consultation request via a telecommunications network by means of a user interface hub;
(ii) in the event of said selected consultant being unavailable for consulting, booking and storing a remote consultation request; subsequently retrieving the consultation request at a later time; establishing the telecommunications link at said later time and initiating the remote consultation;
(iii) timing the duration of the consultation over the link; and
(vi) charging for the consultation.

326. The microbilling system of claim 325 wherein in the event of a selected consultant being available for consulting, the further step of establishing a telecommunications link between a client and said predetermined consultant in response to the request.

327. The microbilling system of claim 325 wherein all communications between said client and said consultant are channeled through a user interface means.

328. The microbilling system of claim 327 wherein said user interface means interfaces with at least a first telephone network for communication with said client.

329. The microbilling system of claim 328 wherein, in the event said consultant is not available for a consultation with said client then said interface means initiates consultation with a second consultant.

330. The microbilling system of claim 325 wherein the step of charging is performed by a billing system which is arranged to bill the client on a time basis, and includes computation means arranged to retrieve timing data from the consultation record database; the billing system including a rates database containing rates data in respect of the various consultants for enabling a consultation fee to be calculated on the basis of the timing data.

331. The microbilling system of claim 325 wherein booking means are provided for booking consultations, the booking means including consultations request storage and retrieval means which are accessible by said consultant.

332. The microbilling system of claim 325 wherein the consultation is telephone-based.

333. The microbilling system of claim 327 implemented via said user interface means and which includes a user interface hub in the form of an interactive voice response (IVR) system.

334. The microbilling system of claim 330 wherein a bill is based on duration of said consultation.

335. The microbilling system of claim 330 adapted to apportion receipts of bills between stakeholders in said system.

336. The microbilling system of claim 325 wherein said consultant can initiate a consultation with said client.

337. The microbilling system of claim 336 wherein said consultant initiates said consultation by supplying a unique identifying feature of that client to said system.

338. The microbilling system of claim 325 wherein said consultant can communicate to said system unavailability of said consultant for a specified period and can nominate to said system an alternative consultant to be substituted by said system for said consultant during said specified period.
